(19) United States
(12) Patent Application Publication
(10) Pub. No.: US 2018/0096441 A1
(43) Pub. Date: Apr. 5, 2018

(54) Method and Apparatus for Facilitating Automatic Arrangement on User's Journey

(71) Applicant: Bayerische Motoren Werke Aktiengesellschaft, Muenchen (DE)

(72) Inventors: Carsten Isert, Muenchen (DE); Biyun Zhou, Shanghai (CN); Andy Chun Liao, Shanghai (CN)

(21) Appl. No.: 15/816,316

(22) Filed: Nov. 17, 2017

Related U.S. Application Data
(63) Continuation of application No. PCT/CN2015/079337, filed on May 20, 2015.

(51) Int. Cl. G06Q 50/14; G06Q 10/02

(52) U.S. Cl. CPC G06Q 50/14; G06Q 10/02

(57) ABSTRACT

A method to facilitate automatic arrangement on a user's journey to a service in queue includes receiving information regarding a queuing condition and a travelling condition. A knowledge database with historical data may be generated from the received information. The historical data may respectively comprises statistical data regarding the queuing condition and the travelling condition associated with specified times or time periods. An estimated time of departure for the user is determined based on the historical data and/or real-time information available in the received information. Then the user can be notified of the determined estimated time of departure. It may save the user's efforts to check the time of departure by using separate tools, thus reducing the inconvenience and improving the user's experience of service.

### CROSS REFERENCE TO RELATED APPLICATIONS

This application is a continuation of PCT International Application No. PCT/CN2015/079337, filed May 20, 2015, the entire disclosure of which is herein expressly incorporated by reference.

### BACKGROUND AND SUMMARY OF THE INVENTION

The present application relates to mobility service, and more particularly, to a method and apparatus for facilitating automatic arrangement on a user′ journey to a queuing service.

In recent years, more and more tools are emerging to facilitate mobility services. A popular one is directed to map and navigation service we usually use. A familiar scenario is that we input a starting point and a destination of a planned journey into a map and navigation tool, such as, an app on a mobile terminal or a dedicated navigation device, and are then notified by the tool of some optional schemes. Each of those schemes may include a recommended route extending from the starting point to the destination, an estimated journey time associated with this route, and possibly current traffic information. The traffic information is generally collected in real time from one or more sources and can be presented to the user with different colors along the recommended route. It is easily recognizable that the estimated journey time changes over time as it is calculated from the real-time traffic information.

Another example of the mobility service is queuing service. Most of users have experienced terrible waiting in a hospital, a bank, or a governmental agency. Sometimes, they have to wait for an unpredictable long time before they are served and even more terribly, cannot do anything but sit or stand in a crowded space because their temporary leave may result in forfeiture of service. Recently, some queuing tools are provided to notify a user how many people, or numbers, are preceding his/her turn and/or how long he/she needs to wait approximately. Thus, it is possible for the user to predict the estimated time of arrival (ETA) when he/she should be available at the service agency. As a result, the user may leave temporarily for other businesses or does not set off until an appropriate time prior to the ETA for a reserved service, thereby improving the user's efficiency and service experience.

However, there is not an available tool to directly predict an Estimated Time of Departure (ETD) for a user who has made reservation on a service in queue. Actually, the user needs to know an approximate ETA by means of a queuing tool and on the other hand, learn a journey time from, for example, a map and navigation tool. Then, the user has to determine an ETD by using separate tools. But, difficulty lies in that the journey time keeps changing with the real-time traffic information and the user needs to keep an eye on the varying journey time and adjust the ETD accordingly. Disadvantageously, the user is often distracted from his/her work because of intermittently checking the ETD.

Another question is the user needs to decide whether to drive his/her private automobile in view of the environmental information regarding parking lot availability near the destination, which may be collected from another separate tool, such as, a parking app. If no parking space will be available during the user's visit, the user has to take third party vehicle (e.g., a taxi or a rented vehicle), a public transportation vehicle or the like. When a third party vehicle is preferred, the user needs to call or make reservation on it by means of a separate transportation calling tool.

To this end, it can be seen that the user has to operate at least two, up to four or even more, tools to arrange a journey to a service in queue. Even worse, most of the information is received in real time and thus keeps varying over time. For example, the queuing information, the traffic information, or the parking information is changing all the time. As a result, the user has to trace the changing real-time information and recalculate the ETD from time to time. This causes great inconvenience to the user. If any real-time information failed to be received, the user would likely make an inaccurate estimation based on the aged information and might miss the service due to late arrival.

Therefore, it is desired to propose a new solution to address at least one of the problems in the prior art.

An object of the present invention is to provide a tool for facilitating automatic arrangement on a user's journey to a service in queue without the user's much involvement.

According to a first aspect of the present invention, a method is provided to facilitate automatic arrangement on a user's journey. The method starts with receiving information regarding a queuing condition and a travelling condition. A knowledge database with historical data can be generated from the received information. The historical data may respectively comprise statistical data regarding the queuing condition and the travelling condition associated with specified times or time periods. Upon receipt of the information, an estimated time of departure for the user can be determined based on the historical data regarding the queuing condition and the travelling condition and/or real-time information regarding the queuing condition and the travelling condition available in the received information. Then the user may be notified of the determined estimated time of departure.

Preferably, the method may further comprise receiving information regarding parking spaces. In this case, the historical data in the knowledge database may further comprise statistical data regarding the parking spaces associated with specified time or time periods. A transportation way for the user can be determined based on the historical data regarding the parking spaces and/or real-time information regarding the parking spaces available in the received information. Then the user may be notified of the determined transportation way.

Preferably, a route from a starting point to a destination of the user's journey may be created. Then a journey time can be calculated based on the travelling condition (s) along the created route.

Preferably, an estimated time of arrival may be determined based on the historical data regarding the queuing condition and/or real-time information regarding the queuing condition available in the received information. The estimated time of departure may be determined as no later than the estimated time of arrival minus the journey time.

According to a second aspect of the present invention, an apparatus is provided to facilitate automatic arrangement on a user's journey. The apparatus may comprise a data receiver, a knowledge database, a data processor, and a user interface. The data receiver can receive information regarding a queuing condition and a travelling condition. The knowledge database may be generated from the received information. The knowledge database may include historical data which may respectively comprise statistical data regarding the queuing condition and the travelling condition associated with specified times or time periods. The data processor can determine an estimated time of departure for the user based on the historical data regarding the queuing condition and the travelling condition and/or real-time information regarding the queuing condition and the travelling condition available in the received information. The user interface can notify the user of the determined estimated time of departure.

Preferably, the data receiver may further receive information regarding parking spaces and/or a driver state. In this situation, the historical data in the knowledge database may further comprise statistical data regarding the parking spaces associated with specified time or time periods. The data processor can further determine a transportation way for the user based on the historical data regarding the parking spaces, real-time information regarding the parking spaces available in the received information, and/or the information regarding the driver state. Then the user interface can further notify the user of the determined transportation way.

According to a third aspect of the present invention, a computer program product is provided comprising a computer readable medium having stored thereon executable program code segments which, when executed on a computing device, cause the computing device to: receive information regarding a queuing condition and a travelling condition, wherein a knowledge database with historical data is generated from the received information, wherein the historical data respectively comprises statistical data regarding the queuing condition and the travelling condition associated with specified times or time periods; and determine an estimated time of departure for the user based on the historical data regarding the queuing condition and the travelling condition and/or real-time information regarding the queuing condition and the travelling condition available in the received information; and notify the user of the determined estimated time of departure.

According to a fourth aspect of the present invention, a computing device is provided to facilitate automatic arrangement on a user's journey. The computing device comprising: a memory that stores computer program instructions; and a processor coupled to the memory and configured, when executing the computer program instructions stored in the memory, to: receive information regarding a queuing condition and a travelling condition, wherein a knowledge database with historical data is generated from the received information, wherein the historical data respectively comprises statistical data regarding the queuing condition and the travelling condition associated with specified times or time periods; determine an estimated time of departure for the user based on the historical data regarding the queuing condition and the travelling condition and/or real-time information regarding the queuing condition and the travelling condition available in the received information; and notify the user of the determined estimated time of departure.

According to one or more aspects of the invention, the user can be notified an Estimated Time of Departure and preferably at least one transportation way without much involvement. It may save the user's efforts to check the time of departure and/or determine an appropriate vehicle by using separate tools, thus reducing the inconvenience due to scheduling a service in queue and improving the user's experience.

Other objects, advantages and novel features of the present invention will become apparent from the following detailed description of one or more preferred embodiments when considered in conjunction with the accompanying drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows a block diagram of an apparatus for facilitating automatic arrangement on a user's journey to an engagement in queue according to one embodiment of the present invention.

FIG. 2 shows a flow chart of a method for facilitating automatic arrangement on a user's journey according to another embodiment of the present invention.

FIG. 3 shows a general hardware configuration of a computing device that is capable of carrying out one or more aspects of the invention according to yet another embodiment of the present invention.

### DETAILED DESCRIPTION OF THE DRAWINGS

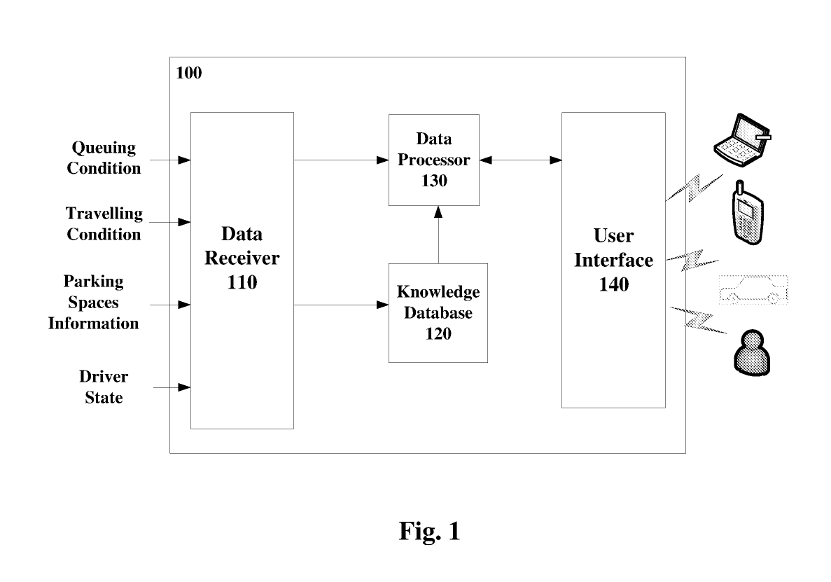

FIG. 1 shows a block diagram of an apparatus 100 for facilitating automatic arrangement on a user's journey to a service in queue according to one embodiment of the present invention. As illustrated in FIG. 1, the apparatus 100 may include a data receiver 110, a knowledge database 120, a data processor 130, and a user interface 140 according to the embodiment of the invention. Information is received by the data receiver 110 from one or more sources. The information may relate to queuing condition (s), travelling condition (s), parking spaces or the like.

In particular, the information regarding queuing conditions may come from, such as, a hospital server. The server can collect registration information and real-time queuing condition in front of a doctor's room, such as, the number of patients to be served before a user, which may be captured by a sensor or camera on site, though not depicted in FIG. 1. It is appreciated that the source of the queuing condition is not limited to the hospital server but may be any entities located in a service agency where queuing may happen.

The information regarding travelling condition may be supplied from one or more sources via an open API (Application Programming Interface). Currently, there are many map and navigation suppliers known and available in the market. They usually can create optional routes from a starting point to a destination based on different rules or algorithms, for example, Shortest Distance Rule, Least Time Rule, Least Fare Rule and so on, acquire and show the real-time traffics along the routes or throughout the map with different colors, for example, green indicating a normal condition, yellow indicating a little jam with an average speed lower than a threshold, red indicating a serious jam with a lower average speed, and calculate an estimated travelling time along each of the recommended routes based on the distances of sections of a route and the sensed real-time speeds on the respective sections. Basically, all the traffic information as stated above is acquired and supplied in real time. These sources are incapable of providing a future travelling condition or a future travelling time. These map and navigation suppliers can supply their map, navigation, or traffic information to a partner via an open API for further processing or use.

The information regarding parking spaces can be supplied from a great number of sensors on the parking facilities, alongside the streets, or on numerous vehicles. It is also possible, maybe more convenient, to acquire such information from a control center which is coupled directly with those sensors and can provide the resulting number of free parking spaces in each of the parking facilities or on each of the streets. It is appreciated that the parking information is also changing all the time and the control center can generally provide the parking information in real time.

When the information regarding the queuing condition, the travelling condition, or the parking spaces is received, the data receiver 110 sends it to both the knowledge database 120 and the data processor 130. In the knowledge database 120, the received information is filtered to remove the “bad” points which may deviate substantially from a statistical curve that is generated from the historical data. These bad points may represent some unusual situations, for example, an unduly long queuing time due to the doctor's leave, and an unduly long travelling time due to a temporary event. If they were not removed, they would adversely affect the average values or other characteristics of the statistic curve at the observed times, consequently resulting in inaccurate estimations. Then clustering is performed on the filtered data to store each piece of information in association with its time stamp when it was captured. For example, a known spatio-temporal method can be used for clustering.

After filtering and clustering, the received information is stored in the knowledge database as valid data. The historical data may be statistical data regarding the queuing condition, the travelling condition, or parking space availability associated with specified times or periods of time. As said above, the statistical data is stored in association with the respective time stamp, for example, a specified time or a specified period of time.

On the other hand, the received information is supplied from the data received 110 to the data processor 130. At the same time, the data processor 130 can retrieve the historical data from the knowledge database 120. Thus, the data processor 130 can generate an Estimated Time of Departure (ETD) for the user based on the historical data and/or the real-time information available in the received information.

An example is provided here assuming a scenario where the user has made a clinic reservation in the afternoon with a registration No. 3. First, the registration number can be transmitted from the hospital device (e.g., a computer) or the user's equipment to the data receiver 110 as the information regarding queuing condition. Then, the data processor 130 can retrieve the historical data from the knowledge database 120, which may indicate simply an average time for each patient to be served or the like derived from the statistical data, or a probability distribution. Accordingly, an Estimated Time of Arrival (ETA) can be determined as the service starting time plus a result by multiplying the number of people ahead with the average time for each people to be served. In this example, assuming the service starts at 1:00 PM and the average time is thirty minutes, the ETA is predicted to be 2:00 PM equal to 1:00 PM plus (30 minutes×2 people ahead). In a more complex way, more than one ETA can be generated with each associated with a probability to be served. For example, the user may be notified of three candidate ETAs, 1:45 PM with a probability of 20% to be served, 2:00 PM with a probability of 50%, and 2:15 PM with a probability of 30%. It is also possible for the data processor 130 to modify the ETA based on the available real-time information regarding the queuing condition. For example, the doctor may be absent during 1:00 PM to 2:00 PM, or it may take an unusually longer time to serve a patient ahead of the user. The ETA will be adjusted accordingly.

Moreover, the information regarding the travelling condition is input to the data processor 130. According to the embodiment of the present invention, the user needs to be notified of the Estimated Time of Departure (ETD) some time earlier than the ETD. In this situation, it is impossible to obtain any real-time traffic information for the user's journey. The data processor 130 may predict a journey time, for example, one hour, for the user to travel from the starting point (e.g., the home) to the destination (here, the hospital) based on the historical data along the recommended route during the specified period of time, such as, 1:00 PM-2:00 PM, which is retrieved from the knowledge database 120. Then, the data processor 130 can determine the ETD as no later than 1:00 PM equal to the ETA, 2:00 PM, minus the predicted journey time, 1 hour.

It is possible for the data processor 130 to modify the journey time predicted from the historical data based on the available real time information regarding travelling conditions. For example, if a soccer game will be held at a stadium on the recommended route during the specified period of time or the weather forecast shows a rain during the specified period of time, the ETD may be advanced to an earlier time, such as, 0:30 PM. The events that may influence the prediction are not limited to the foregoing. When the journey time is modified, the ETD will be adjusted accordingly.

If the user prefers to be notified immediately before departure, it is also possible to determine the ETD from merely the real time information regarding the queuing condition and the travelling condition. It is appreciated that the real time information may become more weighted for determining or updating the ETD than the historical data when the ETD is approaching.

Additionally, the information regarding parking spaces is input to the data processor 130. The data processor 130 can predict the parking space availability near the destination at a specified time or during a specified time period based on the historical data retrieved from the knowledge database 120 and make a recommendation on whether the user should drive his/her own automobile according to the predicted parking space availability. If the prediction shows no or little available parking spaces near the destination during the user's visit, the data processor 130 makes a recommendation that the user may travel by taking a vehicle from a third party service (for example, a taxi, a rented car or the like), taking a public transportation vehicle (for example, bus, subway or the like), riding a bicycle (for example, a non-motor bicycle, a motored bicycle), by walking, or others which can release the user from parking.

Additionally or alternatively, information regarding a driver state may be input to the data receiver 110 and used by the data processor 130 to determine an appropriate transportation way to recommend to the user. For example, if the information shows that the driver is in a drunken, exhausted, or sick state that likely brings about traffic accidents or other types of danger, the data processor 130 may recommend against driving private automobiles, but provide other transportation ways as listed above. As known, the information regarding the driver state can be set by the user on his/her personal device or acquired by a sensing device, and then transmitted to the data receiver 110 in an appropriate communication way.

Further, if the user decides to take a taxi or a vehicle from the third party service in the end, the data processor 130 is capable of automatically make reservation on it by communicating with the control center of the third party (e.g., an App or a server for car renting service, an App or a server for calling taxi). Thus, a vehicle will be ready for the user's riding at the starting point at the ETD. It will significantly improve the user's convenience.

If the user decides to drive his/her own automobile despite of the parking space availability, the data processor 130 can check where the free parking spaces are from the real time information supplied from the data receiver 110 and deliver the current parking information to the user. It can provide a probability distribution of free parking spaces to be expected for a single or a plurality of parking facilities.

As such, the data processor 130 has generated at least the Estimated Time of Departure (ETD) from at least one of the historical data in the knowledge database 120 and the real time information received from the data receiver 110. Additionally, it can determine the transportation way based on the parking space availability and/or the driver state, recommend the optional transportation ways for the user's choice, and reserve a transportation service on the basis of the user's choice.

Then, the data processor 130 supplies the ETD, the recommended transportation way, and/or the reserved transportation service to the user interface 140. The user interface 140, in turn, transmits the above information to a user's equipment, such as, a mobile terminal, a stationary terminal, an on-vehicle device, or the like, which is capable of displaying the information to the user and/or interacting with the user. The user interface 140 can communicate with the user's equipment in any known appropriate way, such as, wirelessly (e.g., a Wireless Local Area Network, a WiMAX network, a Third Generation (3G) Mobile Communication network, an LTE network, Bluetooth™ standard, etc.), a wired connection (e.g., a USB® connection, a Lightening® connection or the like). The user can send information on setting, customization, preferences, requests, options, payment or the like back to the user interface 140 via the user's equipment. For example, the user can input the date of service, the name of the service agency, the registration number, the preferred route, the preferred ETD, the preferred transportation way, the vehicle service or parking facility to be reserved, the preferred payment method, the preferred interface configuration on the display of the equipment, or any other interacting information to the user's equipment to be fed back to the user interface 140. The user interface 140 in turn supplies the input information to the data processor 130 for further processing. It is also appreciated that the data processor 130 can send other information than the ETD and transportation way as described above to the user's equipment in response to the user's request or where necessary. For example, the intermediate data like the ETA, the statistical value (s) of the historical data, the received information, or the like may be supplied to the user's equipment, if desired or necessary.

The notification can be made at specified times or at specified intervals. For example, the user can receive notifications one day, twelve hours, two hours, and half an hour earlier than the ETD. The specified times or intervals can be set by the apparatus 100 or the user. It is also possible to set how many times the notification is popped to the user. Again, with the ETD approaching, the notification can be updated or modified based on the received real-time information.

The embodiment of the invention has been described with respect to FIG. 1. It can be recognized that the apparatus 100 can facilitate automatic arrangement on the user's journey to a service in queue. Initially, the user may be asked to input necessary information like, among other things, the name or location of the service agency and the registration number. The user will then be automatically notified of an ETD and/or optional transportation ways in advance without much involvement. The conventional tools deal with the queuing service, the traffic service, and the parking service separately by means of different suppliers, apparatuses or Apps. However, these types of service are integrated in a single tool provided by the present invention, thereby reducing or avoiding the user's engagement in the arrangement. Ideally, after initially inputting necessary information, the user is released from further involvement until he/she is reminded of an approaching ETD and/or a recommended transportation way, and then takes a vehicle waiting at the starting point when the ETD comes.

In a further embodiment, it is possible for the apparatus 100 to automatically reserve a service with a respective service agency on the user's demand. For example, if a wearable device diagnoses possible illness of the user, it can communicate with the apparatus 100 to make a reservation with a clinic or hospital. Then, the user will be notified of the reserved service, the ETD, and the transportation way. As easily understood, the service (s) is provided here for an exemplary purpose without limitation.

In another further embodiment, a forbidden period of time can be set to be excluded from the ETD. For example, the forbidden period of time may be a busy time when the user has other engagements or the closing time of the service agency.

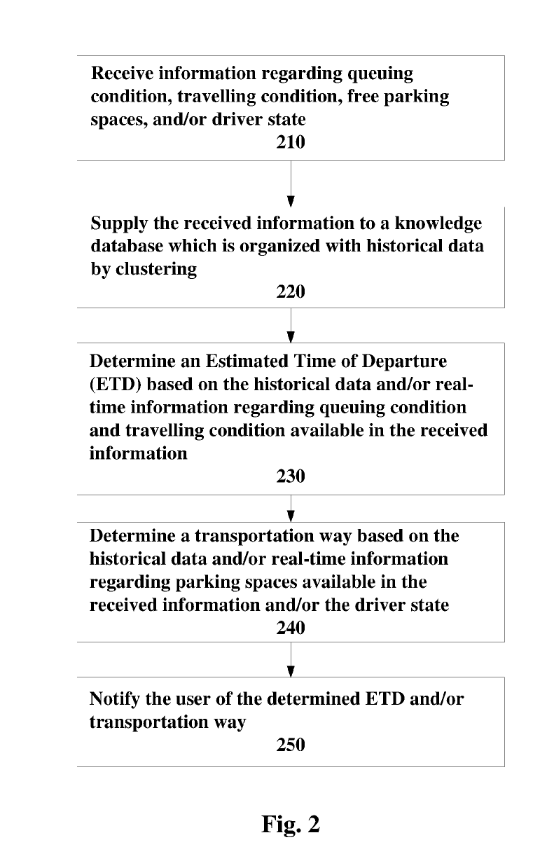

FIG. 2 shows a flow chart of a method 200 for facilitating automatic arrangement on a user's journey to a queuing service according to another embodiment of the present invention. The method 200 starts with step 210 where information regarding queuing condition, travelling condition, parking spaces, and/or a driver state is received. In step 220, the received information is supplied to a knowledge database which is organized with historical data by clustering statistical data regarding queuing condition, travelling condition, and/or parking spaces with respect to specified times or time periods. Preferably, the received information is filtered to remove those bad points that deviate substantially from a learning curve or a distribution curve derived from the historical data before it is organized into the knowledge database as valid data.

Then the method 200 proceeds to step 230 where an estimated time of departure (ETD) is determined for the user based on the historical data regarding the queuing condition and the travelling condition and/or real-time information regarding the queuing condition and the travelling condition available in the received information. In or ahead of this step, an Estimated Time of Arrival (ETA) can be determined based on the information regarding queuing condition, such as, the working time of the service agency, the sequence number for the user to be served, the average time for each people ahead of the user to be served and so on. Then at least one route can be created from a starting point to a destination of the user's journey. Subsequently, the information regarding the travelling condition (s) along the created route can be collected, such as, the distance of the route, traffics on sections of the route, average speeds of travelling vehicles on sections of the route, special events to be held on the route, and weather forecasts. As such, a journey time can be calculated from the collected information. Then, the ETD can be determined to be no later than the ETA minus the journey time, for example.

Furthermore, the method 200 may include a step 240 where at least one transportation way for the user is determined based on the historical data regarding the parking spaces, real-time information regarding the parking spaces available in the received information, and/or the information regarding the driver state. As described above, a transportation way of driving the user's own automobile is possible if a free parking space is available near the destination and the driver is not in a state that is inappropriate for private driving; otherwise, other ways like taking a third party vehicle, taking a public transportation, riding a bicycle, or walking may be recommended in place of private driving. In a further embodiment, the step 240 may include automatically making reservation on a third party vehicle, if necessary or desired.

Next, the method 200 proceeds with the step 250 where the ETD as determined in step 230 and/or the transportation way (s) as determined in step 240 is notified to the user.

It can be appreciated that all the steps depicted in FIG. 2 are not necessary to carry out the method and the sequence in which the steps are performed is not limited to what is shown or described. For example, step 240 may be optional because determination and notification of the ETD in step 230 has accomplished an advantageous aspect of the invention and the action in step 240 may represents an additional advantage. Also, step 240 may precede step 230 without substantial change. For another example, step 220 may be omitted if only real-time information is sufficient for determining the ETD or transportation way. Any modifications or changes that a skilled person in the relevant art can recognize with the teaching of the present disclosure fall within the scope sought to be patented.

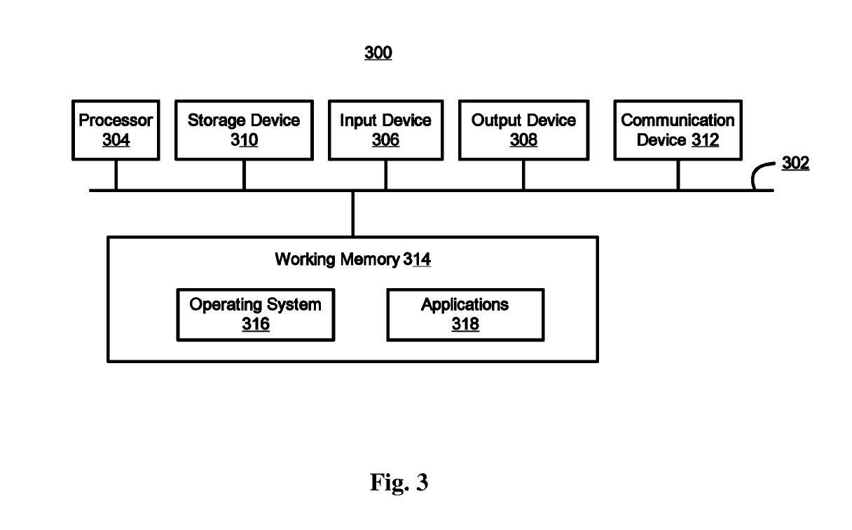

FIG. 3 shows a general hardware configuration of a computing device 300 that is capable of carrying out one or more aspects of the invention according to yet another embodiment of the present invention. The computing device 300 may be any machine configured to perform processing and/or calculations, may be but is not limited to a work station, a server, a desktop computer, a laptop computer, a tablet computer, a personal data assistant, a smart phone, an on-vehicle computer or any combination thereof. The aforementioned apparatus as described with reference to FIG. 1 may be wholly or at least partially implemented by the computing device 300 or a similar device or system.

The computing device 300 may include elements that are connected with or in communication with a bus 302, possibly via one or more interfaces. For example, the computing device 300 may comprise the bus 302, one or more processors 304, one or more input devices 306 and one or more output devices 308. The one or more processors 304 may be any kinds of processors, and may comprise but are not limited to one or more general-purpose processors and/or one or more special-purpose processors (such as special processing chips). The input devices 306 may be any kinds of devices that can input information to the computing device 300, and may be but not limited to a mouse, a keyboard, a touch screen, a microphone and/or a remote control. The output devices 308 may be any kinds of devices that can present information, and may be but not limited to display, a speaker, a video/audio output terminal, a vibrator and/or a printer. The computing device 300 may also comprise or be connected with non-transitory storage devices 310 which may be any storage devices that are non-transitory and can implement data stores, and may comprise but are not limited to a disk drive, an optical storage device, a solid-state storage, a floppy disk, a flexible disk, hard disk, a magnetic tape or any other magnetic medium, a compact disc or any other optical medium, a ROM (Read Only Memory), a RAM (Random Access Memory), a cache memory and/or any other memory chip or cartridge, and/or any other medium from which a computer may read data, instructions and/or code. The non-transitory storage devices 310 may be detachable from an interface. The non-transitory storage devices 310 may have data/instructions/code for implementing the methods and steps which are described above. The computing device 300 may also comprise a communication device 312. The communication device 312 may be any kinds of device or system that can enable communication with external apparatuses and/or with a network, and may comprise but are not limited to a modem, a network card, an infrared communication device, a wireless communication device and/or a chipset such as a Bluetooth™ device, 1302.11 device, WiFi device, WiMax device, cellular communication facilities and/or the like. The data receiver 110 and the user interface 140 as shown in FIG. 1 may, for example, be implemented by the communication device 312.

The computing device 300 may also comprise a working memory 314, which may be any kind of working memory that may store instructions and/or data useful for the operation of the processor 304, and may comprise but is not limited to a random access memory and/or a read-only memory device.

Software elements may be located in the working memory 314, including but are not limited to an operating system 316, one or more application programs 318, drivers and/or other data and codes. Instructions for performing the methods and steps described in the above may be comprised in the one or more application programs 318, and the elements of the aforementioned apparatus 100 may be implemented by the processor 304 reading and executing the instructions of the one or more application programs 318. More specifically, the data processor 130 of the aforementioned apparatus 100 may, for example, be implemented by the processor 304 when executing an application 318 having instructions to perform step 230 and/or step 240. The executable codes or source codes of the instructions of the software elements may be stored in a non-transitory computer-readable storage medium, such as the storage device(s) 310 described above, and may be read into the working memory 314 possibly with compilation and/or installation. The executable codes or source codes of the instructions of the software elements may also be downloaded from a remote location.

Although aspects of the present disclosures have been described by far with reference to the drawings, the method, apparatus, and computing device described above are merely exemplary examples, and the scope of the present invention is not limited by these aspects, but is only defined by the appended claims and equivalents thereof. Various elements may be omitted or may be substituted by equivalent elements. In addition, the steps may be performed in an order different from what is described in the present disclosures. Furthermore, various elements may be combined in various manners. What is also important is that as the technology evolves, many of the elements described may be substituted by equivalent elements which emerge after the present disclosure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for facilitating automatic arrangement on a user's journey to a service in queue, the method comprising:
receiving information regarding a queuing condition and a travelling condition,
generating a knowledge database with historical data from the received information, wherein the historical data respectively comprises statistical data regarding the queuing condition and the travelling condition associated with specified times or time periods;
determining an estimated time of departure for the user based on the historical data regarding the queuing condition and the travelling condition and/or real-time information regarding the queuing condition and the travelling condition available in the received information; and
notifying the user of the determined estimated time of departure.

2. The method of claim 1, further comprising:
receiving information regarding at least one of parking spaces and a driver state, wherein the historical data in the knowledge database further comprises statistical data regarding the parking spaces associated with specified times or time periods;
determining a transportation way for the user based on the historical data regarding at least one of the parking spaces, real-time information regarding the parking spaces available in the received information, and the received information regarding the driver state; and
notifying the user of the determined transportation way.

3. The method of claim 1, wherein the historical data is organized in the knowledge database by clustering the statistical data with respect to the specified times or time periods.

4. The method of claim 1, further comprising creating a route from a starting point to a destination of the user's journey.

5. The method of claim 4, wherein the travelling condition is selected from a group consisting of a distance of said route, traffics along said route, information regarding one or more activities to be held along said route, and weather information.

6. The method of claim 4, further comprising calculating a journey time for the user to travel from the starting point to the destination based on the information regarding the travelling condition.

7. The method of claim 6, wherein said determining the estimated time of departure comprises determining the estimated time of arrival based on the information regarding the queuing condition, and
wherein the estimated time of departure is determined as no later than the estimated time of arrival minus the journey time.

8. The method of claim 1, further comprising filtering the received information before it is input into the knowledge database as valid data.

9. The method of claim 2, wherein said determining the transportation way comprises determining at least one transportation way selected from a group consisting of driving a private vehicle, taking a third party vehicle, taking a public transportation, riding a bicycle, and walking based on the information regarding the parking spaces.

10. The method of claim 9, wherein the notifying the user comprises notifying the user of more than one transportation way as options.

11. The method of claim 10, further comprising automatically reserving a third party vehicle for the user's riding at the estimated time of departure if the user chooses the transportation way of taking the third party vehicle.

12. The method of claim 1, wherein a forbidden period of time is set to be excluded from the estimated time of departure.

13. An apparatus for facilitating automatic arrangement on a user's journey to a service in queue, the apparatus comprising:
a data receiver which receives information regarding a queuing condition and a travelling condition;
a knowledge database generated from the received information, wherein the knowledge database includes historical data which respectively comprises statistical data regarding the queuing condition and the travelling condition associated with specified times or time periods;
a data processor which determines an estimated time of departure for the user based on the historical data regarding the queuing condition and the travelling condition and/or real-time information regarding the queuing condition and the travelling condition available in the received information and
a user interface which notifies the user of the determined estimated time of departure.

14. The apparatus of claim 13, wherein the data receiver further receives information regarding at least one of parking spaces and information regarding a driver state,
wherein the historical data in the knowledge database further comprises statistical data regarding the parking spaces associated with specified time or time periods,
wherein the data processor further determines a transportation way for the user based on the historical data regarding the parking spaces, real-time information regarding the parking spaces available in the received information, and/or the received information regarding the driver state, and
wherein the user interface further notifies the user of the determined transportation way.

15. A computer program product comprising non-transitory computer readable medium having executable program code segments stored thereon which, when executed on a computing device, cause the computing device to:
receive information regarding a queuing condition and a travelling condition, wherein a knowledge database with historical data is generated from the received information, wherein the historical data respectively comprises statistical data regarding the queuing condition and the travelling condition associated with specified times or time periods;
determine an estimated time of departure for the user based on the historical data regarding the queuing condition and the travelling condition and/or real-time information regarding the queuing condition and the travelling condition available in the received information; and
notify the user of the determined estimated time of departure.

16. The computer program product of claim 15, wherein the non-transitory computer readable medium further includes executable program code segments stored thereon which, when executed on a computing device, cause the computing device to:
receive information regarding at least one of parking spaces and a driver state, wherein the historical data in the knowledge database further comprises statistical data regarding the parking spaces associated with specified times or time periods;
determine a transportation way for the user based on the historical data regarding at least one of the parking spaces, real-time information regarding the parking spaces available in the received information, and the received information regarding the driver state; and
notify the user of the determined transportation way.

17. The computer program product of claim 15, wherein the non-transitory computer readable medium further includes executable program code segments stored thereon which, when executed on a computing device, cause the computing device to create a route from a starting point to a destination of the user's journey.
